(19) United States
(12) Patent Application Publication
(10) Pub. No.: US 2014/0242686 A1
(43) Pub. Date: Aug. 28, 2014

(54) TRASH COMPOSTING APPARATUS

(71) Applicant: James L. Adkins, Upper Tumon, GU (US)

(72) Inventor: James L. Adkins, Upper Tumon, GU (US)

(21) Appl. No.: 14/188,514

(22) Filed: Feb. 24, 2014

Related U.S. Application Data
(60) Provisional application No. 61/768,349, filed on Feb. 22, 2013.

(51) Int. Cl. C05F 17/02

(52) U.S. Cl. CPC C05F 17/0223
USPC 435/290.3

(57) ABSTRACT

A system for decomposing materials includes a main container and a drum container housed within the main container. The drum container includes a central longitudinal axis about which the drum container rotates. The drum container also includes at least one partition extending transverse to the central longitudinal axis of the drum container dividing the drum container into a first compartment and a second compartment. The partition includes a central aperture in alignment with the central longitudinal axis allowing for the passage of decomposing material between the first compartment and the second compartment as decomposing material rises to a level exceeding the distance from an outer wall of the drum container thereof to a circumferential edge of the central aperture. A venting pipe radially extends within the drum container.

### CROSS REFERENCE TO RELATED APPLICATION

This application claims the benefit of a U.S. Provisional Application Ser. No. 61/768,349, entitled “TRASH COMPOSITING APPARATUS,” filed Feb. 22, 2013.

### BACKGROUND OF THE INVENTION

1. Field of the Invention

The present invention relates to an apparatus for processing and disposal of materials, in particular, trash. The present invention further relates to an efficient and cost effective system for decomposing trash, thereby decreasing the amount of trash that needs to be hauled away from a facility.

2. Description of the Related Art

With population growth and the resulting increase in trash production, our urban and suburban populations are confronted with trash handling problems. However, current trash handling solutions offer only limited solutions in the problems associated with hauling trash away from a facility. For example, such solutions as compacting or scheduling more pick up times offer only limited assistance in decreasing trash that must be hauled.

As such, a need continues to exist for trash handling solutions allowing for the processing and disposal of trash in a cost effective and efficient manner. The present invention provides such a solution.

### SUMMARY OF THE INVENTION

It is, therefore, an object of the present invention to provide a system for decomposing materials. The system comprises a main container and a drum container housed within the main container. The drum container includes a central longitudinal axis about which the drum container rotates. The drum container also includes at least one partition extending transverse to the central longitudinal axis of the drum container dividing the drum container into a first compartment and a second compartment. The partition includes a central aperture in alignment with the central longitudinal axis allowing for the passage of decomposing material between the first compartment and the second compartment as decomposing material rises to a level exceeding the distance from an outer wall of the drum container thereof to a circumferential edge of the central aperture. A venting pipe radially extends within the drum container.

It is also an object of the present invention to provide a system for decomposing materials wherein the venting pipe extends from an outlet end secured to the wall of the drum container to an inlet end located in substantial alignment with the central longitudinal axis of the drum container such that gases may flow from the inlet end of the first venting pipe, to the outlet end of the venting pipe, and out of the drum container.

It is another object of the present invention to provide a system for decomposing materials wherein the inlet end of the venting pipe is provided with a swivel pipe ensuring that an opening of the swivel pipe at the inlet end of the venting pipe is always facing downward as the drum container rotates.

It is a further object of the present invention to provide a system for decomposing materials wherein the main container includes a vent.

It is also an object of the present invention to provide a system for decomposing materials wherein the main container includes an electrically powered vent.

It is another object of the present invention to provide a system for decomposing materials wherein the drum container is substantially cylindrical.

It is a further object of the present invention to provide a system for decomposing materials wherein a plurality of rollers support the drum container for rotation within the main container.

It is also an object of the present invention to provide a system for decomposing materials further including a motor rotating the drum container within the main container.

It is another object of the present invention to provide a system for decomposing materials wherein the drum container includes five partitions, each with a central aperture, dividing the drum container into the first compartment, the second compartment, a third compartment, a fourth compartment, a fifth compartment and a sixth compartment.

It is a further object of the present invention to provide a system for decomposing materials wherein the venting pipe is positioned adjacent the first partition, a second venting pipe is positioned adjacent the second partition, a third venting pipe is positioned adjacent the third partition and a fourth venting pipe is positioned adjacent the fourth partition.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a side cross sectional view of the present system for decomposing material.

FIG. 2 is a cross sectional view along the section line A in FIG. 1.

FIG. 3 is a cross sectional view along the section line B in FIG. 1.

FIG. 4 is a cross sectional view along the section line C in FIG. 1.

FIG. 5 is a cross sectional view along the section line D in FIG. 1.

FIG. 6 is a side plan view of the motor shown in FIG. 5.

FIG. 7 is a top plan view of the main container.

FIG. 8 is a side plan view of the main container

FIG. 9 is an end view of the main container.

FIG. 10 is a cross sectional view of drum container.

FIG. 11 is a cross sectional view along the section line A in FIG. 10.

FIG. 12 is a cross sectional view along the section line B in FIG. 10.

FIG. 13 is a cross sectional view along the section line C in FIG. 10.

FIG. 14 is a top plan view of the base wall of the main container which functions as the support base for the drum container

FIG. 15 is a cross sectional view along the section line A in FIG. 14.

FIG. 16 is a cross sectional view along the section line B in FIG. 14.

FIG. 17 is a cross sectional view along the section line C in FIG. 14.

FIG. 18 is a cross sectional view along the section line D in FIG. 14.

FIGS. 19 and 20 are respective side plan views of the motor from different orientations.

FIG. 21 is a side view of the drum container with internal components shown in broken lines.

FIG. 22 is a side view of a venting pipe in accordance with the present invention.

FIG. 23 is a side view of the auger and inlet for the drum container.

### DESCRIPTION OF THE PREFERRED EMBODIMENT

The detailed embodiment of the present invention is disclosed herein. It should be understood, however, that the disclosed embodiment is merely exemplary of the invention, which may be embodied in various forms. Therefore, the details disclosed herein are not to be interpreted as limiting, but merely as a basis for teaching one skilled in the art how to make and/or use the invention.

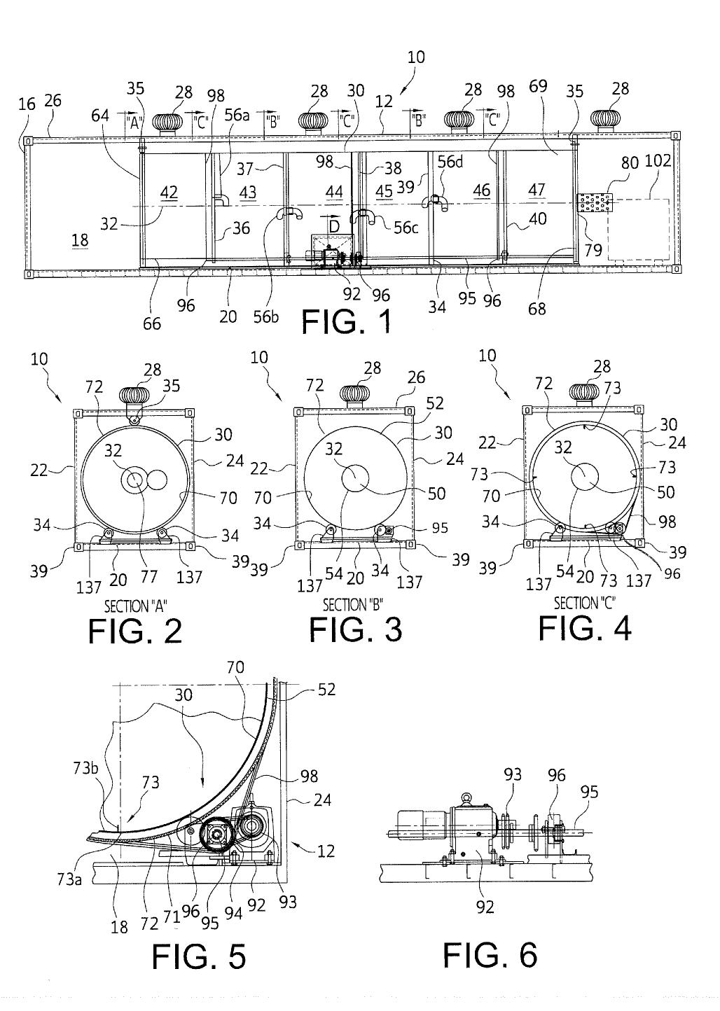

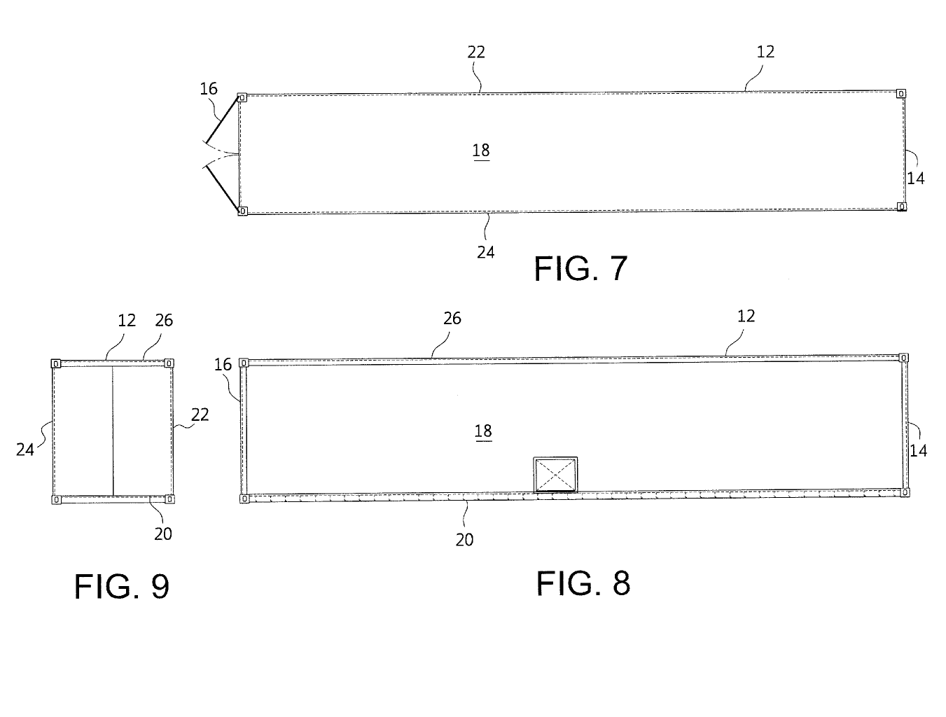

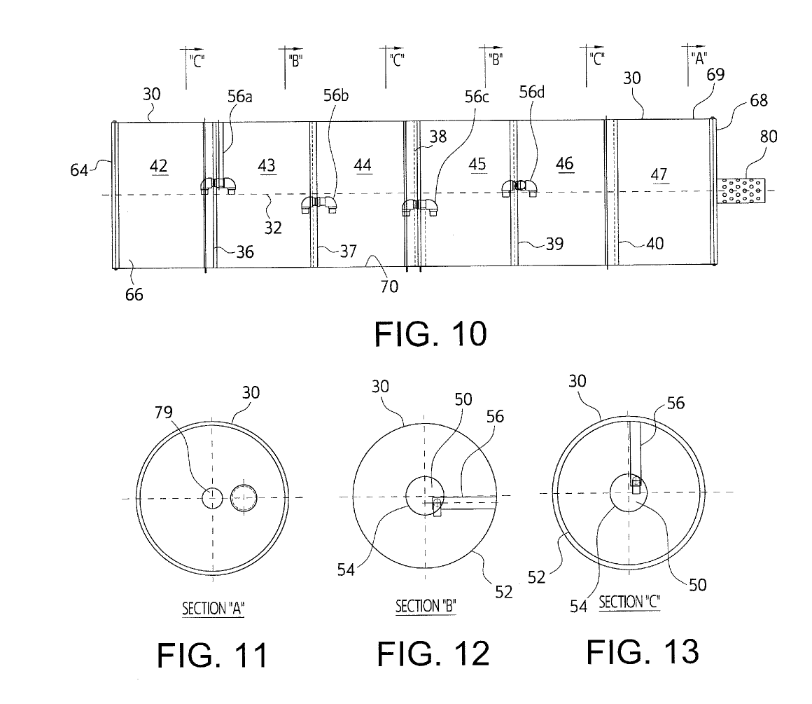

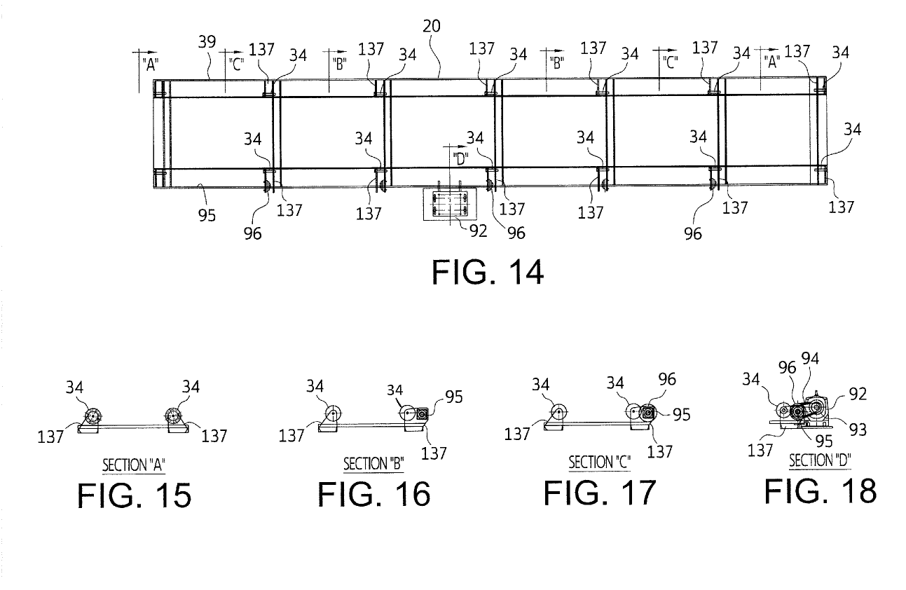

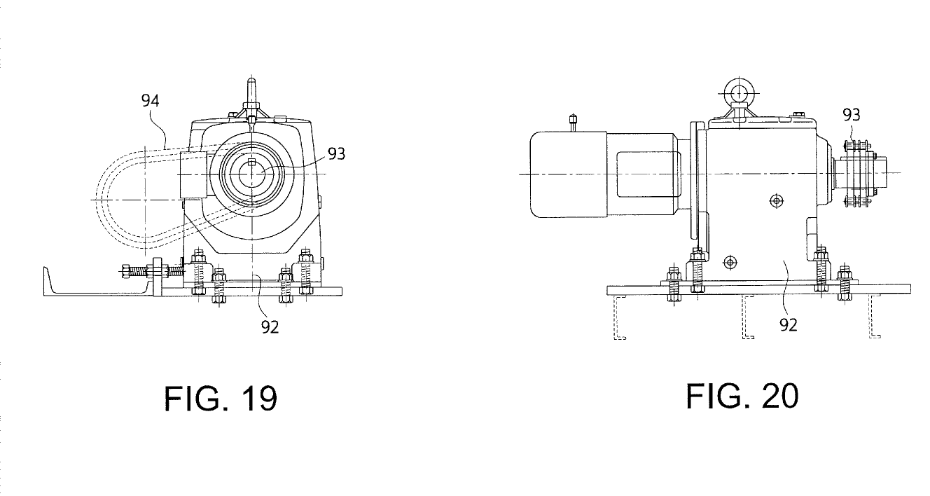

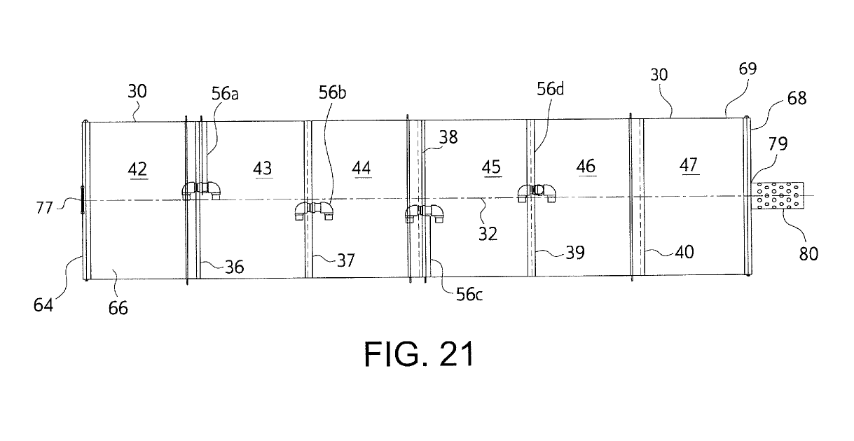

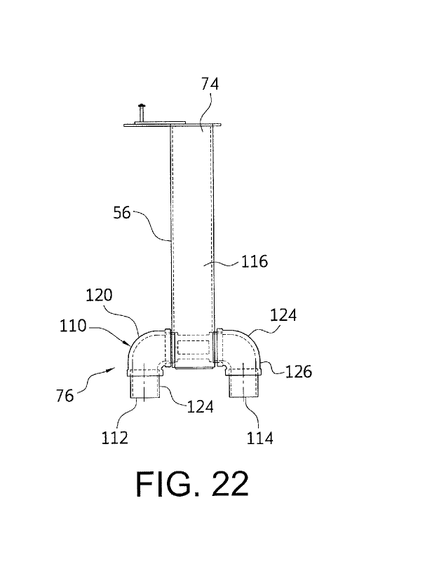

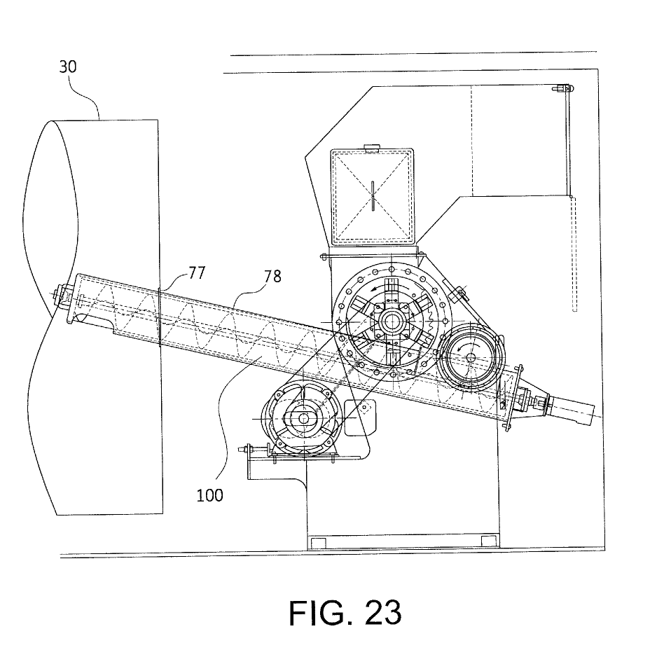

In accordance with the present invention, and with reference to FIGS. 1 to 23, a system 10 for decomposing materials, in particular, trash is disclosed. The system 10 includes a main container 12 in which the functional components of the system 10 are housed. In accordance with a preferred embodiment, the main container 12 is rectangular and includes a rear wall 14, a pivotally mounted front wall 16 permitting access to the interior 18 of the main container 12, a base wall 20, first and second side walls 22, 24, and a top wall 26.

The size of the main container 12 may be varied depending upon the size of the operating components and ultimately the volume of trash that must be handled by the present system 10. The main container 12 may be a conventional cargo shipping container used when transporting materials via ships. The main container 12 is designed for venting of fumes therefrom and, therefore, includes a vent 28 located along the top wall 26 thereof. While the vent is located on the top wall in accordance with a preferred embodiment, it is appreciated other vent positions are possible within the spirit of the present invention.

A drum container 30 is housed within the main container 12. In accordance with a preferred embodiment, the drum container 30 is substantially cylindrical and includes a central longitudinal axis 32 extending longitudinally along the center of the drum container 30 when viewed along a cross section taken along a plane perpendicular to the central longitudinal axis 32 of the drum container 30. The drum container 30 is supported within the main container 12 for rotation about the central longitudinal axis 32. As such, and while the main container 12 is large enough to permit rotation of the drum container 30 therein, the drum container 30 is shaped and dimensioned such that its diameter is smaller than the width and height of the main container 12.

Rotation of the drum container 30 within the main container 12 is achieved by the provision of rollers 34 supporting the drum container 30 relative to the base wall 20 and the top wall 26 of the main container 12. The rollers 34 located adjacent the base wall 20 are positioned in pairs such that they support opposite side of the drum container 30 along the length of the drum container 30. The rollers are held in position using angle supporting bracket 137 which position the rollers along the base of the drum container 30. In particular, the supporting brackets 137 are welded to steel channels 39 formed along the base wall 20 of the main container 12 so as to define a support base for the drum container 30. A roller 35 is also positioned adjacent the top wall 26 to engage the apex, that is, the highest point, of the cylinder defined by the drum container 30.

The drum container 30 includes a first end wall 64 located at the first end 66 of the drum container 30, an opposite second end wall 68 located at the second end 69 of the drum container 30. The drum container also includes a cylindrical outer wall 52. The first end wall 64 includes an inlet opening 77 and the second end wall 68 includes an outlet opening 79. The cylindrical outer wall 52 includes an interior surface 70 and an exterior surface 72. As will be explained below in greater detail, and with reference to FIGS. 4 and 5, the interior surface 70 of the drum container 30 is provided with a plurality of longitudinally extending, that is, extending in a direction substantially parallel to the central longitudinal axis 32 of the drum container 30, L-brackets 73. Each of the L-brackets 73 includes an attachment arm 73a directly secured to the interior surface 70 of the drum container 30 and an engagement arm 73b extending perpendicular to the attachment arm 73a for interaction with decomposing materials.

Rotational movement of the drum container 30 within the main container 12 and about the central longitudinal axis 32 of the drum container 30 is achieved by the provision of a motor 92 that is sized and configured for controlled rotation of the drum container 30. In accordance with a preferred embodiment, and with reference to FIGS. 5 and 6, the motor 92 is linked to the drum container 30 via a first link drive chain 94 driven by a sprocket 93 of the motor 94. The first link drive chain 94 drives a gear drive shaft 95 with a plurality of wheels 96 mounted thereon. The gear wheels 96 are spaced along the length of drum 30 and supported by supporting brackets 137, that then drives a drum belt 98 that wraps about the drum container 30 and frictionally engages the exterior surface 72 of the drum container 30. Engagement of the drum belt 98 with the exterior surface 72 of the drum container 30 is further enhanced by the provision of mating teeth 71 on both the drum and the belt. In particular, the exterior surface of the drum is provided with outward facing teeth that mesh with inward facing teeth formed along the inner surface of the belt. It is also appreciated, that the teeth may be replaced with smooth, highly frictionally surfaces.

The drum container 30 includes at least one partition extending transverse to the central longitudinal axis 32 of the drum container 30 dividing the drum container 30 into a first compartment 42 and a second compartment 44. In accordance with a preferred embodiment, and as shown in FIGS. 1, 10-13, and 20, the drum container 30 includes five partitions 36, 37, 38, 39, 40 dividing the drum container 30 into first compartment 42, a second compartment 43, a third compartment 44, a fourth compartment 45, a fifth compartment 46 and a sixth compartment 47.

Each of the partitions 36, 37, 38, 39, 40 includes a central aperture 50 in alignment with the central longitudinal axis 32 of the drum container 30. The central aperture 50 includes a circumferential edge 54 and is shaped and dimensioned to allow for the passage of bio decomposing trash between adjacent compartments, for example, trash will pass from the first compartment 42 to the second compartment 43, as decomposing trash rises to a level exceeding the distance from the cylindrical outer wall 52 of the drum container 30 to the circumferential edge 54 of the central aperture 50.

Venting pipes 56a-d are provided in the second compartment 43, the third compartment 44, the fourth compartment 45 and the fifth compartment 46. More particular, the venting pipes 56a-d are respectively positioned adjacent the first partition 36, the second partition 37, the third partition 38 and the fourth partition 39. Although the venting pipes 56a-d are oriented at differential circumferential positions relative to the drum container 30, they are substantially identical. As such, only the venting pipe 56b of the third compartment 44 will be described herein, although it is appreciated all of the venting pipes are identical.

The venting pipe 56b radially extends within the third compartment 44. As discussed above, the drum container 30 is substantially cylindrical and includes a central longitudinal axis 32. The drum container 30 includes the closed first end wall 64 located at the first end 66 of the drum container 30 and the closed second end wall 68. The cylindrical outer wall 52 includes an interior surface 70 and an exterior surface 72. The venting pipe 56b includes an outlet end 74 and an inlet end 76. The outlet end 74 of the venting pipe 56b extends through the cylindrical outer wall 52 of drum container 30 for venting fumes from the interior of the drum container 30 in a manner discussed below in greater detail.

The inlet end 76 of the venting pipe 56b is positioned in substantial alignment with the central longitudinal axis 32 of the drum container 30 such that gases may flow from the inlet end 76 of the venting pipe 56, to the outlet end 74 of the venting pipe 56, and out of the drum container 30. In accordance with a preferred embodiment, the inlet end 76 of the venting pipe 56 is provided with a swivel pipe 110 ensuring that the openings 112, 114 of the swivel pipe 110 at the inlet end 76 are always facing downward as the drum container 30 is rotated such that material may not spill therein (see various venting pipes 56a-d at various orientations, all with the openings facing downwardly).

In particular, the swivel pipe 110 is in fluid communication with the primary passageway 116 of the venting pipe 56b such that gases may freely flow from the openings 112, 114 formed in the swivel pipe 110, through the swivel pipe 110, and into the primary passageway 116 of the venting pipe 56b where there they are vented out the outlet end 74 of the venting pipe 56b. As such, the swivel pipe 110 includes a C-shaped construction with a transverse cylinder 118 rotatably secured to the primary passageway 116 at the inlet end 76 of the venting pipe 56b. The transverse cylinder 118 connects a first lateral opening 112 and a second lateral opening 114 to the primary passageway 116 of the venting pipe 56b that leads to the outlet end 74 of the venting pipe 56b. The transverse cylinder 118 is oriented substantially perpendicular to the primary passageway 116 and parallel to the longitudinal axis 32 of the drum container 30, and the transverse cylinder 118 includes a first end 120 and a second end 122. The first end 120 of the transverse cylinder 118 is secured to a first short inlet passageway 124 that ultimately defines the first lateral opening 112, while the second end 122 of the transverse cylinder 118 is secured to a second short inlet passageway 126 that ultimately defines the second lateral opening 114. The first and second short inlet passageways 124, 126 are oriented perpendicular to the transverse cylinder 118 and parallel to the primary passageway 116 of the venting pipe 56b. By rotatably connecting the swivel pipe 110 to the primary passageway 116 at the inlet end 76 of the venting pipe 56b, the first and second lateral openings 112, 114 are always facing downwardly under the force a gravity as the drum container 30 rotates and decomposing material within the drum container 30 may not fall into the first and/or second inlet passageways 124, 126. Thereby, allowing the drum container 30 to be continuously vented as it rotates about is central longitudinal axis 32.

As the venting pipe 56b is located adjacent the second partition 37 in the third compartment 44, the transverse cylinder 118 extends within the central aperture 50 between the second compartment 43 and the third compartment 44 such that the first lateral opening 112 is positioned within the second compartment 43 and the second lateral opening 114 is positioned within the third compartment 44.

The venting pipe 56 is securely held in position adjacent the second partition 38 using bracket members securing it in position along its length as it extends from its inlet end 76 to its outlet end 74.

With the description of the venting pipe 56b in mind, it is appreciated the other venting pipes 56a, 56c, 56d are similarly positioned to vent from adjacent compartments. In particular, the venting pipe 56a is located adjacent the first partition 36 in the second compartment 43, the transverse cylinder 118 extends within the central aperture 50 between the first compartment 42 and the second compartment 43 such that the first lateral opening 112 is positioned within the first compartment 42 and the second lateral opening 114 is positioned within the second compartment 43. The venting pipe 56c is located adjacent the third partition 38 in the fourth compartment 45, the transverse cylinder 118 extends within the central aperture 50 between the third compartment 44 and the fourth compartment 45 such that the first lateral opening 112 is positioned within the third compartment 44 and the second lateral opening 114 is positioned within the fourth compartment 45. The venting pipe 56d is located adjacent the fourth partition 39 in the fifth compartment 46, the transverse cylinder 118 extends within the central aperture 50 between the fourth compartment 45 and the fifth compartment 46 such that the first lateral opening 112 is positioned within the fourth compartment 45 and the second lateral opening 114 is positioned within the fifth compartment 46.

In practice, trash is forced into the first compartment 42 through an inlet pipe 78 passing through the inlet opening 77 formed in the closed first end wall 64 of the drum container 30. The inlet pipe 78 includes an input end 128 into which waste is introduced into the inlet pipe 78 and an outlet end 130 from which waste is ejected from the inlet pipe 78 into the first compartment 42 of the drum container 30. In accordance with a preferred embodiment, the inlet pipe 78 is oriented a slight angle such that the output end 130 is positioned above the input end 128. As will be explained below in greater detail, due to the geometric relation between the inlet opening 77 of drum container 30, the input end 128 of the inlet pipe 78, the output end 130 of the inlet pipe 78, and the central aperture 50, once trash enters the first compartment 42 it can only, and will only, exit through central aperture 50 positioned between the first compartment 42 and the second compartment 43. In accordance with a preferred embodiment, a powered discharge device in the form of an auger 100 forces the trash through the inlet pipe 78.

As will be appreciated based upon the following disclosure, because the inlet opening 77 in first end wall 64 is smaller than the central aperture 50 in the first partitions 36, and the output end 130 of the inlet pipe 78 is higher than either the inlet opening 77 or the input end 128 of the inlet pipe 78, there is no need to worry that trash will be forced back down and out of the inlet pipe 78 when the first compartment 42 becomes filled. Due to the geometric relation between the inlet opening 77 of the first closed end wall and the central aperture 50, once trash enters the first compartment 42 it can only, and will only, exit through central aperture 50. This is a result of the bottom of the inlet opening 77 always being higher than the bottom of the central aperture when the drum is at rest or rotating.

Because of the arrangement of the central apertures 50 formed in the various partitions 36, 37, 38, 39 and 40, as the drum container 30 rotates the trash tumbles and moves to the lower part of the drum. As such, the trash flows through the drum container 30 moving from the inlet opening 77 formed in the first end wall 64 and out the outlet opening 79 formed in the second end wall 68 and out discharge pipe 80 in communication therewith. The flow of trash from the inlet pipe 78 to the discharge pipe 80 is further facilitated by the provision of directional fins, that is, the L-brackets 73 with engagement arm 73a discussed above, along the interior surface 70 of the drum container 30. The directional fins 73 are oriented in manner encouraging trash within the drum container to move from the inlet pipe 78 toward the discharge pipe 80 by moving toward the lowest parts of the drum container 30 as the drum container 30 is rotated. The fins 73 also provide a mechanism for enhancing the tumbling of trash as the drum container 30 is rotated in accordance with the present invention. In particular, the engagement arms 73a will engage decomposing material sitting along the interior surface 70 and pull it with the rotation of the drum container 30. This action results in multiple beneficial results, including, the breakdown of the decomposing material into small pieces, the incorporation of oxygen into the mixture, and the cooling of the decomposing material.

It should first be appreciated the drum container 30 is rotated during the process described herein. Whether the drum container 30 is periodically rotated or the drum container 30 rotates continuously, does not matter to the operation of the present system 10.

As trash is put into the first compartment 42, the first compartment 42 will fill until such a time the level of the trash exceeds the distance from the interior surface 70 of the container's cylindrical outer wall 52 to the circumferential edge 54 of the central aperture 50. When the trash reaches this level, the level of the trash in conjunction with the rotational movement of the trash imparted by the rotation of the drum container 30 and the fins will cause the trash rising above the circumferential edge 54 to fall through the central aperture 50 into the second compartment 43. This movement of trash within the drum container 30 is facilitated by the action of gravity forcing the top of the trash pile extending over the circumferential edge 54 in the direction of least resistance, that is, through the central aperture 50 and into the adjacent compartment.

This process will continue, filling the second compartment 43, and then the third compartment 44, the fourth compartment 45, the fifth compartment 46 and final the sixth compartment 47. Once the sixth compartment 47 fills, the bio decomposing trash will be fully to partially composted and will exit the discharge pipe 80 in the same manner the trash moves between the various compartments 42, 43, 44, 45, 46, 47 and through the central apertures 50. It is appreciated that is cannot be guaranteed that the material will be fully composted as depending on how much trash is inputted and the time the material stays in the container the biodegradable may not have enough time to be fully composted. It may be 50, 75, or 90 percent composted but one will not be certain as to whether it has been fully composted. One will, however, know the compost process has begun.

As such, the outlet opening 79 and discharge pipe 80 are centrally positioned and include a diameter substantially similar to the diameters of the central aperture 50 providing for a continuous flow of material through the system 10 and out the discharge pipe 80 in to a trash carts 102 that may be wheeled from within the main container 12. With provision of a trash cart 102 at the outlet opening 79 of the drum container 30, the rear wall 14 of the main container 12 is easily opened, for example, by structuring the rear wall as a hinged wall secured to either the first or second side walls. In is, however, appreciated, the discharge pipe could extend to the exterior of the main compartment such that processes trash is discharged to a collection bin positioned exterior of the main container.

Further, and although the inlet pipe 78 and discharge pipe 80 are oriented to facilitate controlled movement of trash into and out of the drum container 30, it is contemplated controlled movement into and out of the drum container 30 may be achieved using various mechanisms, for example, pneumatic shoots or mechanical conveyors.

As those skilled in the art will appreciate, the decomposition of trash taking place through the use of the present system 10 will result in the generation of various fumes. It is, therefore, desirous to continuously vent these fumes from the drum container 30, into the interior of the main container 12 and through the vent 28 into the external environment where they may harmlessly spread into the external environment.

The venting of fumes from the drum container 30 is facilitated by the venting pipe 56 extending radially within the drum container 30. Because the inlet end 76 of the venting pipe 56 is located at a position in alignment with the central longitudinal axis 32 and within the longitudinally extending cylindrical space defined by the central apertures 50, the trash never covers or clogs the inlet end 76 of the venting pipe 56. As such, fumes continually vent therethrough and are discharged to the interior of the main container 12 via the outlet end 74 of the venting pipe 56. In order to ensure that build-up of decomposing material within the respectively compartments 42, 44, 46 and 48 does not cause covering of the inlet end 76 of the venting pipe 56, the venting pipe 56 are positioned adjacent the central apertures 50 along the outlet side thereof. As such as pressure builds up in each compartment it will be forced out the respective venting pipe or pipes in each compartment.

As should be appreciate based upon the preceding disclosure, the drum container 30 defines a generally open system 10 permitting the free flow of air there through as such as fumes travel out the venting pipes fresh air will be drawn in. The vent 28 is preferably a wind powered vent, although it is appreciated the vent may be an electrically powered vent creating forced airflow throughout the present system if needed. The flow of air in this manner helps facilitate to the decomposition of the trash passing through the present system.

In conjunction with the previously described system, it is appreciated a compost starter may be utilized. The compost starter is mixed with the first trash that is put into the drum. Composting is a natural process as we use this process to reduce any offense odors. It is also appreciated that there is no set time when trash is in compartments. The more trash that is inputted in the intake the faster the trash will move from each compartment and out the discharge pipe.

While the preferred embodiments have been shown and described, it will be understood that there is no intent to limit the invention by such disclosure, but rather, is intended to cover all modifications and alternate constructions falling within the spirit and scope of the invention.

1. A system for decomposing materials comprising:
a main container;
a drum container housed within the main container;
the drum container includes a central longitudinal axis about which the drum container rotates, the drum container also includes at least one partition extending transverse to the central longitudinal axis of the drum container dividing the drum container into a first compartment and a second compartment;
the partition includes a central aperture in alignment with the central longitudinal axis allowing for the passage of decomposing material between the first compartment and the second compartment as decomposing material rises to a level exceeding the distance from an outer wall of the drum container thereof to a circumferential edge of the central aperture;
a venting pipe radially extending within the drum container.

2. The system for decomposing material according to claim 1, wherein the venting pipe extends from an outlet end secured to the wall of the drum container to an inlet end located in substantial alignment with the central longitudinal axis of the drum container such that gases may flow from the inlet end of the first venting pipe, to the outlet end of the venting pipe, and out of the drum container.

3. The system for decomposing material according to claim 1, wherein the inlet end of the venting pipe is provided with a swivel pipe ensuring that an opening of the swivel pipe at the inlet end of the venting pipe is always facing downward as the drum container rotates.

4. The system for decomposing trash according to claim 1, wherein the main container includes a vent.

5. The system for decomposing trash according to claim 1, wherein the main container includes an electrically powered vent.

6. The system for decomposing trash according to claim 1, wherein the drum container is substantially cylindrical.

7. The system for decomposing trash according to claim 1, wherein a plurality of rollers support the drum container for rotation within the main container.

8. The system for decomposing trash according to claim 1, further including a motor rotating the drum container within the main container.

9. The system for decomposing trash according to claim 1, wherein the drum container includes five partitions, each with a central aperture, dividing the drum container into the first compartment, the second compartment, a third compartment, a fourth compartment, a fifth compartment and a sixth compartment.

10. The system for decomposing trash according to claim 9, wherein the venting pipe is positioned adjacent the first partition, a second venting pipe is positioned adjacent the second partition, a third venting pipe is positioned adjacent the third partition and a fourth venting pipe is positioned adjacent the fourth partition.
